(19) United States
(12) Patent Application Publication
(10) Pub. No.: US 2024/0199827 A1
(43) Pub. Date: Jun. 20, 2024

(54) MEANS FOR PREPARING A POLYMER FILM, AND A POLYMER FILM PREPARED THEREOF

(71) Applicants: NANODOCKS TECHNOLOGY LIMITED, Hong Kong (CN); CITY UNIVERSITY OF HONG KONG, Hong Kong (CN)

(72) Inventors: Jinlian HU, Hong Kong (CN); Shuo SHI, Hong Kong (CN); Yifan SI, Hong Kong (CN); Jieqiong YANG, Hong Kong (CN); Siu Wah WONG, Hong Kong (CN)

(21) Appl. No.: 18/080,869

(22) Filed: Dec. 14, 2022

(51) Int. Cl. C08J 5/18; B29C 71/02

(52) U.S. Cl. CPC C08J 5/18; C08J 7/08; C08J 2327/16; C08J 2375/04

(57) ABSTRACT

The present invention relates to a method for preparing a polymer film, comprising the following steps: preparing a polymer film with a polymer solution prepared from PVDF and/or TPU; preparing a mixed solvent selected from a group consisting of dimethylformamide, dimethylacetamide, ethanol, water, or any combination thereof, wherein said mixed solvent is characterized by the solubility of said mixed solvent to the polymer selected for said polymer solution and/or the contact angle of said mixed solvent on said polymer film; wetting said polymer film with said mixed solvent; and subjecting the wet polymer film to thermal treatment under pressure.

### FIELD OF THE INVENTION

The present invention is concerned with a method for preparation a polymer film. More particularly, the present invention is concerned with a method for post-processing an electrospinning spinning film to enhance the mechanical properties.

### BACKGROUND

Waterproof and moisture-permeable membrane materials are widely used in the fields of waterproof and moisture-permeable clothing, architectural fabric membranes and smart wearables. These materials have a good market prospect and increasing demand. The current waterproof and moisture-permeable membrane materials in a form of fabrics on the market are represented, for example, by expanded polytetrafluoroethylene and its homologous microporous films.

Commonly used waterproof and moisture-permeable membrane materials are expanded polyethylene film and polytetrafluoroethylene (PTFE). PTFE by the company Gore-Tex is a porous film prepared by thermal stretching technology. Said film involves many layouts and thus the processing is complex and expensive, such high technology barriers hinder these materials being popularly used.

Current researches look into using processing methods, other than thermal stretching, such as electrospinning to prepare waterproof and moisture-permeable materials by assembling layers of a polymer film, which comprises fibers, in particular nanofibers. However, fibers, in particular nanofibers, within each film layer and in different layers have no bonding therebetween, therefore film layers, prepared by the electrospun fibers, are easily separated. Therefore, although these materials are waterproof and moisture-permeable but have weak mechanical properties in general.

The present invention seeks to address such problems, or at least to provide an alternative to the public. It is desirable to provide an electrospun film with bonded structure thus providing high mechanical properties.

### SUMMARY

In a first aspect of the present invention, it relates to a method for preparing a polymer film, comprising the following steps: a) preparing a polymer film with a polymer solution prepared from polyvinylidene fluoride (PVDF) and/or thermoplastic polyurethane (TPU); b) preparing a mixed solvent selected from a group consisting of dimethylformamide, dimethylacetamide, ethanol, water, or any combination thereof, wherein said mixed solvent is characterized by the solubility of said mixed solvent to the polymer selected for said polymer solution and/or the contact angle of said mixed solvent on said polymer film; c) wetting said polymer film with said mixed solvent; and d) subjecting the wet polymer film to thermal treatment under pressure.

In one embodiment, the solubility of said mixed solvent to the polymer selected for said polymer solution is 4.2 wt % to 11.2 wt %.

In another embodiment, the contact angle of said mixed solvent on said polymer film is 29° to 83°.

Advantageously, said wet polymer film is subjected to hot-pressing. Said wetting in step c) can be coating process, in particular dip coating or spin coating.

In one embodiment, said wet polymer film is subjected to hot-pressing at 60° C. under pressure of 50 to 350 Pa. Preferably, in step 1c), said mixed solvent to said polymer film is in a weight ratio of 0.5. More preferably, in step 1a), said polymer film is prepared by electrospinning said polymer solution. Advantageously, in step 1c), the fibers in said polymer film are semi-dissolved or partially dissolved. More advantageously, the fibers semi-dissolved or partially dissolved in step 1c) are linked after said thermal treatment.

In a second aspect of the present invention, it relates to a polymer film prepared by the first aspect, characterized in that the breaking strength of said polymer film is increased by at least 150%.

In a third aspect of the present invention, it relates to a polymer film prepared by the first aspect, characterized in that the hydrostatic pressure resistance of said polymer film is increased by at least 120%.

In a fourth aspect of the present invention, it relates to a composite which comprises polymer films prepared in the first aspect. The composite is suitable to prepare waterproof and moisture-permeable membrane materials for clothing, architectural fabric membranes and smart wearables.

### BRIEF DESCRIPTION OF THE DRAWINGS

Some embodiments of the present invention will now be explained, with reference to the accompanied figures, in which:—

FIG. 1 shows a flow chart for preparing an electrospun film of the present invention;

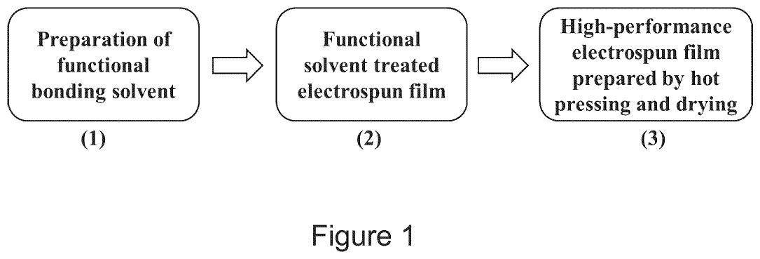

FIG. 2 is an SEM photographic image showing an electrospun PVDF film of one embodiment of the present invention before post-processing treatment; Insert in FIG. 2 is the magnified view on one area of the SEM photographic image in FIG. 2;

FIG. 3 is an SEM photographic image showing an electrospun PVDF film of one embodiment of the present invention after post-processing treatment; Insert in FIG. 3 is the magnified view on one area of the SEM photographic image in FIG. 3; and

FIG. 4 shows mechanical strength test results of two electrospun PVDF films of embodiments of the present invention, in which one is before post-processing and the other one is after post-processing treatment.

### DETAILED DESCRIPTION OF PREFERRED EMBODIMENTS OF THE INVENTION

This disclosure is now presented by way of examples with reference to the figures in the following paragraphs. Objects, features, and aspects of the present disclosure are disclosed in or are apparent from the following description. It is to be understood by one of ordinary skilled in the art that the following discussion is a description of exemplary embodiments only, and is not intended as limiting the broader aspects of the present disclosure, which broader aspects are embodied in the exemplary constructions.

All percentages described herein are by weight percent of the composition, unless otherwise specified.

Unless otherwise specified, all chemicals described herein are commercially available and are used as received, which may include impurities, for example, residual solvents or by-products. Machine for preparing a film by electrospinning is performed by an electrospun machine provided by Kato Tech Co. The contact angle of the film is tested by an optical video contact angle instrument (Lunderskov, Denmark).

Electrospinning films prepared in certain embodiments below may comprise the following general steps:
1 Preparation of an electrospun film
a) preparation of a polymer solution
b) electrospinning the polymer solution prepared in step 1a) to form an electrospun film. Electrospinning process, for example, performed in an electrospinning device at voltage of 26 kV, an advance rate of 0.5 ml/h at room temperature, distance of tip-to-collector at 10 cm.
2) Preparation of a mixed solvent
a) preparation of a mixed solvent, characterized in that the solubility of the polymer in the mixed solvent is in certain range and that the contact angle of the mixed solvent on the electrospun film is in certain range.
3) Post-processing the electrospun film
a) uniform coating, for example spin coating or dip coating, the electrospun film with the mixed solvent prepared in step 2a), in certain proportion to the weight of the electrospun film
b) hot-pressing and drying the coated electrospun film prepared in step 3a), preferably for 1-2 hours. Post-processed electrospun films with bonded structures are then prepared.

Embodiments prepared with general steps described above but with specific formulations and conditions are illustrated below. Polyvinylidene fluoride (PVDF) is selected as illustrative examples for embodiments 1-8 and 17 as materials to prepare an electrospun film. Thermoplastic polyurethane (TPU) is selected as illustrative examples for embodiments 9-16 and 18 as materials to prepare an electrospun film.

### Embodiment 1

Bonded PVDF electrospun film (the following parts are parts by weight):
1) Prepare a mixed solvent of DMF (Dimethylformamide) and water, the ratio is 60:40, the solubility of PVDF in the mixed solvent is 9.8%, and the contact angle of the mixed solvent on the electrospun film is 41°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and a positive pressure of 50 Pa for 1 hour to prepare a high-performance PVDF electrospun film with a bonded structure.

### Embodiment 2

Bonded PVDF electrospun film (the following parts are parts by weight):
1) Prepare a mixed solvent of DMF and water, the ratio is 50:50, the solubility of PVDF in the mixed solvent is 8.5%, and the contact angle of the mixed solvent on the electrospun film is 52°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and a positive pressure of 50 Pa for 1 hour to prepare a high-performance PVDF electrospun film with a bonded structure.

### Embodiment 3

Bonded PVDF electrospun film (the following parts are parts by weight):
1) Prepare a mixed solvent of DMF and water, the ratio is 40:60, the solubility of PVDF in the mixed solvent is 5.1%, and the contact angle of the mixed solvent on the electrospun film is 82°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and a positive pressure of 50 Pa for 1 hour to prepare a high-performance PVDF electrospun film with a bonded structure.

### Embodiment 4

Bonded PVDF electrospun film (the following parts are parts by weight):
1) Prepare a mixed solvent of DMF and ethanol, the ratio is 60:40, the solubility of PVDF in the mixed solvent is 11.2%, and the contact angle of the mixed solvent on the electrospun film is 29°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and a positive pressure of 50 Pa for 1 hour to prepare a high-performance PVDF electrospun film with a bonded structure.

### Embodiment 5

Bonded PVDF electrospun film (the following parts are parts by weight):
1) Prepare the mixed solvent of DMF and ethanol, the ratio of 50:50, the solubility of PVDF in the mixed solvent is 8.3%, and the contact angle of the mixed solvent on the electrospun film is 42°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and a positive pressure of 50 Pa for 1 hour to prepare a high-performance PVDF electrospun film with a bonded structure.

### Embodiment 6

Bonded PVDF electrospun film (the following parts are parts by weight):
1) Prepare a mixed solvent of DMF and ethanol, the ratio is 40:60, the solubility of PVDF in the mixed solvent is 6.3%, and the contact angle of the mixed solvent on the electrospun film is 54°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and a positive pressure of 50 Pa for 1 hour to prepare a high-performance PVDF electrospun film with a bonded structure.

### Embodiment 7

Bonded PVDF electrospun film (the following parts are parts by weight):
1) Prepare a mixed solvent of DMF and water, the ratio is 40:60, the solubility of PVDF in the mixed solvent is 6.3%, and the contact angle of the mixed solvent on the electrospun film is 54°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and a positive pressure of 150 Pa for 1 hour to prepare a high-performance PVDF electrospun film with a bonded structure.

### Embodiment 8

Bonded PVDF electrospun film (the following parts are parts by weight):
1) Prepare a mixed solvent of DMF and water, the ratio is 40:60, the solubility of PVDF in the mixed solvent is 6.3%, and the contact angle of the mixed solvent on the electrospun film is 54°.
2) Coat the mixed solvent uniformly on the PVDF electrospun film, and the usage amount of the mixed solvent is 0.5 times that of the PVDF film.
3) The PVDF electrospun film treated with the mixed solvent is dried at 60° C. and 350 Pa for 1 hour to prepare a high-performance PVDF electrospun film with a bonded structure.

### Embodiment 9

Bonded TPU electrospun film (the following parts are parts by weight):
1) Prepare a mixed solvent of DMF and water, the ratio is 60:40, the solubility of TPU in the mixed solvent is 8.3%, and the contact angle of the mixed solvent on the electrospun film is 34°.
2) Coat the mixed solvent uniformly on the TPU electrospun film, the usage amount of the mixed solvent is 0.5 times that of the TPU film.
3) Dry the TPU electrospun film treated with the mixed solvent at 60° C. and a positive pressure of 50 Pa for 1 hour to prepare a high-performance PVDF electrospun film with a bonded structure.

### Embodiment 10

Bonded TPU electrospun film (the following parts are parts by weight):
1) Prepare a mixed solvent of DMF and water, the ratio is 50:50, the solubility of TPU in the mixed solvent is 6.5%, and the contact angle of the mixed solvent on the electrospun film is 43°.
2) Coat the mixed solvent uniformly on the TPU electrospun film, the usage amount of the mixed solvent is 0.5 times that of the TPU film.
3) Dry the TPU electrospun film treated with the mixed solvent at 60° C. and a positive pressure of 50 Pa for 1 hour to prepare a high-performance TPU electrospun film with a bonded structure.

### Embodiment 11

Bonded TPU electrospun film (the following parts are parts by weight):
1) Prepare a mixed solvent of DMF and water, the ratio is 40:60, the solubility of TPU in the mixed solvent is 4.2%, and the contact angle of the mixed solvent on the electrospun film is 76°.
2) Coat the mixed solvent uniformly on the TPU electrospun film, the usage amount of the mixed solvent is 0.5 times that of the TPU film.
3) Dry the TPU electrospun film treated with the mixed solvent at 60° C. and a positive pressure of 50 Pa for 1 hour to prepare a high-performance TPU electrospun film with a bonded structure.

### Embodiment 12

Bonded TPU electrospun film (the following parts are parts by weight):
1) Prepare a mixed solvent of DMF and ethanol, the ratio is 60:40, the solubility of TPU in the mixed solvent is 11.5%, and the contact angle of the mixed solvent on the electrospun film is 31°.
2) Coat the mixed solvent uniformly on the TPU electrospun film, the usage amount of the mixed solvent is 0.5 times that of the TPU film.
3) Dry the TPU electrospun film treated with the mixed solvent at 60° C. and a positive pressure of 50 Pa for 1 hour to prepare a high-performance TPU electrospun film with a bonded structure.

### Embodiment 13

Bonded TPU electrospun film (the following parts are parts by weight):
1) Prepare the mixed solvent of DMF and ethanol, the ratio is 50:50, the solubility of TPU in the mixed solvent is 8.9%, and the contact angle of the mixed solvent on the electrospun film is 34°.
2) Coat the mixed solvent uniformly on the TPU electrospun film, the usage amount of the mixed solvent is 0.5 times that of the TPU film.
3) Dry the TPU electrospun film treated with the mixed solvent at 60° C. and a positive pressure of 50 Pa for 1 hour to prepare a high-performance TPU electrospun film with a bonded structure.

### Embodiment 14

Bonded TPU electrospun film (the following parts are parts by weight):
1) Prepare a mixed solvent of DMF and water, the ratio is 40:60, the solubility of TPU in the mixed solvent is 7.4%, and the contact angle of the mixed solvent on the electrospun film is 41°.
2) Coat the mixed solvent uniformly on the TPU electrospun film, the usage amount of the mixed solvent is 0.5 times that of the TPU film.
3) Dry the TPU electrospun film treated with the mixed solvent at 60° C. and a positive pressure of 50 Pa for 1 hour to prepare a high-performance TPU electrospun film with a bonded structure.

### Embodiment 15

Bonded TPU electrospun film (the following parts are parts by weight):
1) Prepare a mixed solvent of DMF and water, the ratio is 40:60, the solubility of TPU in the mixed solvent is 7.4%, and the contact angle of the mixed solvent on the electrospun film is 41°.
2) Coat the mixed solvent uniformly on the TPU electrospun film, the usage amount of the mixed solvent is 0.5 times that of the TPU film.
3) Dry the TPU electrospun film treated with the mixed solvent at 60° C. and a positive pressure of 150 Pa for 1 hour to prepare a high-performance TPU electrospun film with a bonded structure.

### Embodiment 16

Bonded TPU electrospun film (the following parts are parts by weight):
1) Prepare a mixed solvent of DMF and water, the ratio is 40:60, the solubility of TPU in the mixed solvent is 7.4%, and the contact angle of the mixed solvent on the electrospun film is 41°.
2) Coat the mixed solvent uniformly on the TPU electrospun film, the usage amount of the mixed solvent is 0.5 times that of the TPU film.
3) The TPU electrospun film treated with the mixed solvent is dried at 60° C. and a positive pressure of 350 Pa for 1 hour to prepare a high-performance TPU electrospun film with a bonded structure.

### Embodiment 17

PVDF electrospun film (the following parts are parts by weight):
1) Prepare water with solubility to PVDF is 0%, and the contact angle of the mixed solvent on the electrospun film is 135°.
2) Coat water evenly on the PVDF electrospun film, and the amount of water used is 0.5 times that of the PVDF film.
3) The PVDF electrospun film after water treatment is dried at 60° C. and a positive pressure of 50 Pa for 1 hour to prepare a post-processed PVDF electrospun film.

### Embodiment 18

TPU electrospun film (the following parts are parts by weight):
1) Prepare water with solubility to TPU is 0%, and the contact angle of the mixed solvent on the electrospun film is 135°.
2) Coat water evenly on the TPU electrospun film, the amount of water used is 0.5 times that of the TPU film.
3) The TPU electrospun film after water treatment is dried at 60° C. and a positive pressure of 50 Pa for 1 hour to prepare a post-treated TPU electrospun film.

Although PVDF and TPU are selected as illustrative examples for embodiments 1-18 as materials to prepare the electrospun films, however it shall be understood that the present invention is also applicable on films prepared by PVDF and TPU. In other words, the present invention is applicable on a polymer film prepared by a polymer solution comprising PVDF and/or TPU. Although the mixed solvent illustrated in embodiments 1-16 is DMF-water in embodiments 1-3, 6-11, 14-16, and DMF-ethanol in embodiments 4 and 12, it shall be understood that solvents suitable for preparing the mixed solvent according to the present invention is selected from a group consisting of DMF, water, ethanol, dimethylacetamide (DMAc), and in combination thereof. It shall be understood that any solvent or mixed solvent that can semi-dissolve or partially dissolve the electrospun film falls into the scope of the present invention. For sake of brevity, examples of solvent or mixed solvent are not described herein. Further, it shall also be understood that the mixed solvent prepared according to the present invention is suitable for the prepared electrospun film according to the present invention comprising PVDF and/or TPU. For sake of brevity, embodiments above do not illustrate all possibilities. It shall be understood that every specific numerical point for parameter described in embodiments in this context (for example: mixing ratio between solvents, solubility of solvent to polymer, solubility of polymer in solvent, contact angle of mixed solvent on electrospun film, hot-pressing temperature in post-treatment, pressure in post-treatment, etc.) can be used as an end point for a numerical range for said parameter in embodiments according to the present invention. In other words, said end point is included in the numerical range. It shall also be understood that every numerical value in said numerical range can be an end point for another numerical range for said parameter in embodiments according to the present invention.

Embodiments prepared as described above are subject to testing for breaking strength, moisture permeability (WVP), and hydrostatic pressure resistance.

The breaking strength test is performed according to ASTM D 882 standard. Embodiments 1 to 8 are measured by Instron 5566 tensile machine (condition: temperature is 23′C, relative humidity is 50%) test er, as shown in Table 1.

The WVP test is performed according to ASTM E96 BW standard. Embodiments 1 to 8 are measured by Haida HD-100T constant temperature and humidity box (condition: temperature is 23° C., relative humidity is 50%) test er, as shown in Table 1.

The hydrostatic pressure resistance test is performed according to Adopt JIS L1092 A standard. Electrospun film prepared in the embodiments is covered with a layer of Trickett knitted fabric. Embodiments 1 to 8 are measured by the FX3000 hydrostatic pressure tester, as shown in Table 1.

Test results for breaking strength, moisture permeability (WVP), and hydrostatic pressure resistance for embodiments 1-18 are list in table 1, as below:

TABLE 1

| | Broken | | Hydrostatic |
|---|---|---|---|
| | strength | WVP | pressure |
| Items | (MPa) | (g/m² · d) | (mm H₂O) |
| Embodiment 1 | 16.3 | 15710 | 4220 |
| Embodiment 2 | 17.9 | 16220 | 3690 |
| Embodiment 3 | 19.2 | 15220 | 4110 |
| Embodiment 4 | 17.3 | 15220 | 4510 |
| Embodiment 5 | 18.1 | 16120 | 4810 |
| Embodiment 6 | 18.6 | 14910 | 5210 |
| Embodiment 7 | 19.2 | 15720 | 5280 |
| Embodiment 8 | 22.1 | 16120 | 5310 |
| Embodiment 9 | 18.1 | 16210 | 2800 |
| Embodiment 10 | 19.2 | 16910 | 3100 |
| Embodiment 11 | 23.1 | 15790 | 3310 |
| Embodiment 12 | 19.1 | 16110 | 3210 |
| Embodiment 13 | 25.2 | 15910 | 3330 |
| Embodiment 14 | 26.1 | 16280 | 3410 |
| Embodiment 15 | 28.1 | 16230 | 3490 |
| Embodiment 16 | 30.4 | 16720 | 3530 |
| Embodiment 17 | 9.4 | 15210 | 3510 |
| Embodiment 18 | 12.7 | 16280 | 2210 |

Table 1 above shows that the breaking strength of the films in embodiments 1 to 8 are from 16.3 to 22.1 Mpa, all at least above 16 MPa. Comparing with the embodiment 17, which uses only water as solvent that is equivalent to no post-processing treatment on the PVDF electrospun film, the breaking strength of the film in embodiment 17 is 9.4 Mpa. It shows that the breaking strength of the films in embodiments 1 to 8 is at least 1.5 times stronger than the untreated PVDF electrospun film in embodiment 17.

Table 1 above also shows that the breaking strength of the films in embodiments 9 to 16 ranges from 18.1 to 30.4 Mpa, all at least above 18 MPa. Comparing with the embodiment 18, which uses only water as solvent that is equivalent to no post-processing treatment on the TPU electrospun film, the breaking strength of the film in embodiment 18 is 12.7 Mpa. It shows that the breaking strength of the films in embodiments 9 to 16 is at least 1.5 times stronger than the untreated TPU electrospun film in embodiment 18.

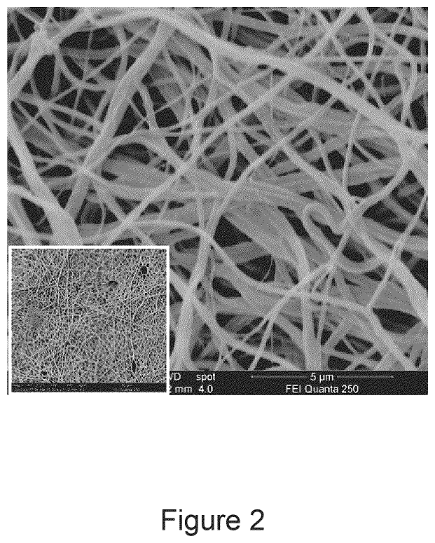

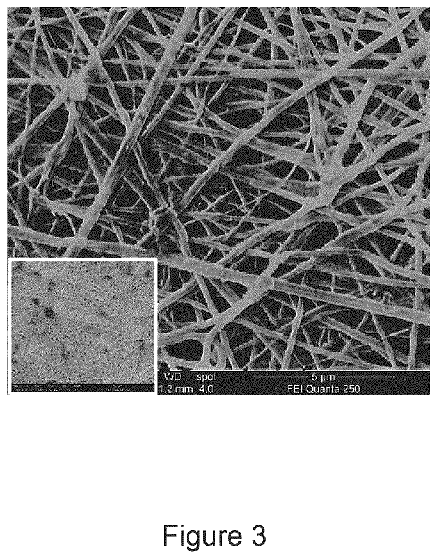

FIGS. 2-3 are SEM photographic images showing the effect of post-processing treatment on an electrospun PVDF film according to the present invention, in which FIG. 2 is before post-processing treatment and FIG. 3 is after post-processing treatment. Inserts in FIGS. 2-3 are the magnified view on one area of the SEM photographic images in FIGS. 2-3, respectively. It can be seen that the fibers in FIG. 2 are individual-like and entangled, whereas the fibers in FIG. 3 are linked and disentangled.

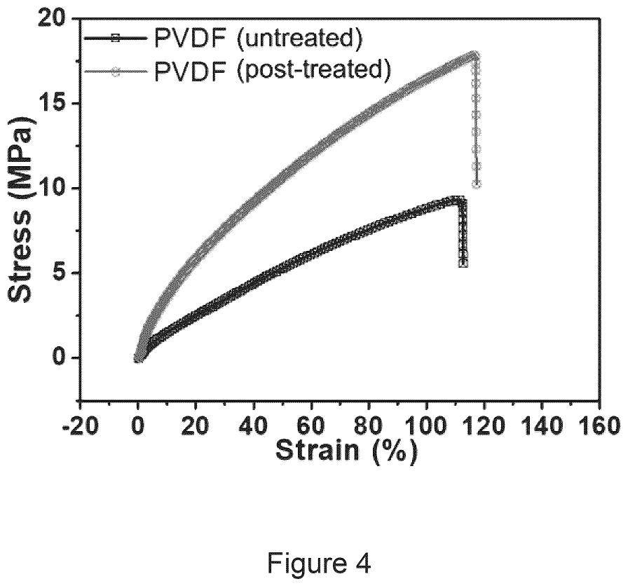

FIG. 4 shows mechanical strength test results of two electrospun PVDF films of embodiments of the present invention, in which one is before post-processing and the other one is after post-processing treatment.

It can be seen from Table 1 above that the moisture permeability of the film in embodiment 17 is 15210 g/m²·d. Moisture permeability of the electrospun films in embodiments 1-8 ranges are all substantially the same as that in embodiment 17, indicating the post-processing treatment has no adverse effect after implementing the post-processing treatment on an untreated PVDF electrospun film.

It can be seen from Table 1 above that the moisture permeability of the film in embodiment 18 is 16280 g/m²·d. Moisture permeability of the electrospun films in embodiments 9-16 ranges are all substantially the same as that in embodiment 18, indicating the post-processing treatment has no adverse effect after implementing the post-processing treatment on an untreated TPU electrospun film.

Table 1 indicates the results of hydrostatic pressure resistance of embodiments 1-18. As seen, the hydrostatic pressure resistance of the films in embodiments 1 to 8 is at least 1.2 times higher than the untreated PVDF electrospun film in embodiment 17. The hydrostatic pressure resistance of the films in embodiments 9 to 16 is at least 1.2 times higher than the untreated TPU electrospun film in embodiment 18.

Post-processing treatment according to the present invention provides a novel and inventive means to semi-dissolve or partially dissolve nanofibers in the electrospun film, with controllable manner, by selected solvent, such that during the drying process, for example in step 3b) in the general steps described foregoing, the semi-dissolved or partially dissolved nanofibers physically contacts with each other, in particular in-situ bonded or linked to each other, and thus forming a contact point between each other, as shown in FIG. 3, and eventually forming a robust bonded-structure. Experiment results show that before post-processing treatment, nanofibers slide under tensile strain, however after post-processing treatment, since nanofibers are linked to form a bonded structure, sliding between nanofibers is restricted and therefore the broken strain in embodiments 1-16 is enhanced. Post-processing treatment provides physical bonding between the electrospun film fibers, enabling an electrospun three-dimensional network structure with strengthening points (the contact points between nanofibers) is constructed, realizing electrospun film prepared according to the present invention with high strength. The obtained electrospun film has better mechanical properties, moisture permeability and hydrostatic pressure resistance. Meanwhile, the preparation according to the present invention is streamlined, simple, and viable to be industrialized.

The description of the above embodiments is only used to help understanding the method and core idea of the present invention. For those of ordinary skill in the art, without departing from the principle of the present invention, several improvements and modifications can be made to the present invention, and these improvements and modifications also fall within the protection scope of the claims of the present invention. Various modifications to these embodiments are obvious to those skilled in the art, and the general principles defined herein can be implemented in other embodiments without departing from the spirit or scope of the present invention. Therefore, the present invention will not be limited to the embodiments shown in this document but should conform to the widest scope consistent with the principles and novel features disclosed in this document and their equivalents.

What is claimed is:

1. A method for preparing a polymer film, comprising the following steps:
a) preparing a polymer film with a polymer solution prepared from polyvinylidene fluoride (PVDF) and/or thermoplastic polyurethane (TPU);
b) preparing a mixed solvent selected from a group consisting of dimethylformamide, dimethylacetamide, ethanol, water, or any combination thereof, wherein said mixed solvent is characterized by the solubility of said mixed solvent to the polymer selected for said polymer solution and/or the contact angle of said mixed solvent on said polymer film;
c) wetting said polymer film with said mixed solvent; and
d) subjecting the wet polymer film to thermal treatment under pressure.

2. A method as claimed in claim 1, wherein the solubility of said mixed solvent to the polymer selected for said polymer solution is 4.2 wt % to 11.2 wt %.

3. A method as claimed in claim 1, wherein the contact angle of said mixed solvent on said polymer film is 29° to 83°.

4. A method as claimed in claim 1, wherein said wet polymer film is subjected to hot-pressing.

5. A method as claimed in claim 4, wherein said wet polymer film is subjected to hot-pressing at 60° C. under pressure of 50 to 350 Pa.

6. A method as claimed in claim 1, wherein in step 1c), said mixed solvent to said polymer film is in a weight ratio of 0.5.

7. A method as claimed in claim 1, wherein in step 1a), said polymer film is prepared by electrospinning said polymer solution.

8. A method as claimed in claim 1, wherein in step 1c), the fibers in said polymer film are semi-dissolved or partially dissolved.

9. A method as claimed in claim 8, wherein the fibers semi-dissolved or partially dissolved in step 1c) are linked after said thermal treatment.

10. A polymer film prepared by a method as claimed in claim 1, characterized in that the breaking strength of said polymer film is increased by at least 150%.

11. A polymer film prepared by a method as claimed in claim 1, characterized in that the hydrostatic pressure resistance of said polymer film is increased by at least 120%.
